(19) United States
(12) Patent Application Publication
(10) Pub. No.: US 2005/0217155 A1
(43) Pub. Date: Oct. 6, 2005

(54) Hand gesture receiver

(76) Inventor: Michael Santa Cruz, Pomona (CA)

Correspondence Address: MICHAEL A. SHIPPEY, PH. D., 4848 LAKEVIEW AVENUE, SUITE B, YORBA LINDA, CA, 92886, US

(21) Appl. No.: 10/813,518

(22) Filed: Mar. 30, 2004

(51) Int. Cl. G09F 21/04

(52) U.S. Cl. 40/591

(57) ABSTRACT

A driver courtesy device that enables the driver to display his message to other drivers utilizing a trailer hitch located at the rear of the vehicle. This device is designed to allow complete freedom of expression utilizing hand gestures to communicate a message or greeting to other drivers in the rear vicinity of the automobile. The present art is created by combining a silicone rubber-based compound (V 1065) cast-molded over one-quarter inch aluminum armature wire in the form of a human hand manufactured in a myriad of colors and textures. The combination of the silicone-based rubber and armature wire provide excellent flexibility along with position memory characteristics that are unique to any existing novelty receiver hitch on the market today. The digits are pliable, yet stiff enough to mimic most common hand gestures. Once moved into place, the digits hold their position even in rain or adverse weather conditions.

### FIELD OF INVENTION

This invention relates to the field of courtesy devices and, more particularly, to courtesy devices mounted to a trailer hitch and is visible to other drivers within the vicinity of the automobile.

### DESCRIPTION OF RELATED ART

The closest prior art has designed a courtesy device visible to drivers from the rear window of an automobile. This device consists of 2 parts: A transmitter component attachable to the dashboard and a display unit which mounted adjacent the rear or side window. The display unit includes an upstanding member resembling an arm followed by a hand, which is reciprocated in a linear motion to simulate a waving hand to convey a courteous gesture possible with a motor attached to this display unit. Upon the driver of the automobile activating the transmitter via a switch mechanism, a signal is transmitted wirelessly to the receiver in the display unit, which starts the waving movement of the member until a timer deactivates the motor thus stopping the movement. The prior art is very limited in its design with just one gesture—a waving hand. The present art is only limited to the driver's creativity and the complexity of the hand gesture, if any. There exists numerous hand gestures courteous or not, that are easily created utilizing the present invention.

### SUMMARY OF THE INVENTION

The present invention is a novelty device directed to send a visual message to other drivers in the vicinity of the automobile utilizing the rear trailer hitch. The present invention utilizes a combination of one-quarter inch aluminum armature wire, which is covered by cast-molding a silicone rubber-based compound (V 1065) in different colors in the form of a human hand. This produces a human hand with digits strong and stiff enough to retain its position in adverse conditions, such as winds or rain, yet flexible and pliable enough to create a myriad of hand gestures only limited to the driver's imagination. The fingers and thumb can be positioned to mimic most hand gestures and hold their position once moved, unlike mannequin devices. The combination of these materials provide stable, yet flexible digits which feature position memory characteristics which are unique to any existing novelty receiver on the market today. The present invention is mounted to a male hitch, which is inserted into the receiver hitch and secured with a pin, not unlike most hitches in use today. The present invention is designed to be manufactured in a rainbow of colors and textures to appeal to a wide range of drivers.

### BRIEF DESCRIPTION OF DRAWINGS

FIG. 1: A rear view of the present invention displaying a “peace sign”, which is mounted from the trailer hitch.

FIG. 2: A side view of the present invention which shows how the hand gesture is mounted to the receiving hitch of the motor vehicle. Note the pin which locks the hitch in place.

FIG. 3: A rear/side view of the present invention also showing how the hand gesture is mounted to the receiving hitch with pin to lock it in.

FIG. 4: A skeleton view of the pliable armature wire underneath the silicone-based rubber of the present invention.

FIG. 5: Rear view of the present invention displaying “hello”.

FIG. 6: Rear view of the present invention displaying “hang loose”.

FIG. 7: Rear view of the present invention displaying “alien handshake”.

### DETAILED DESCRIPTION OF THE DRAWINGS

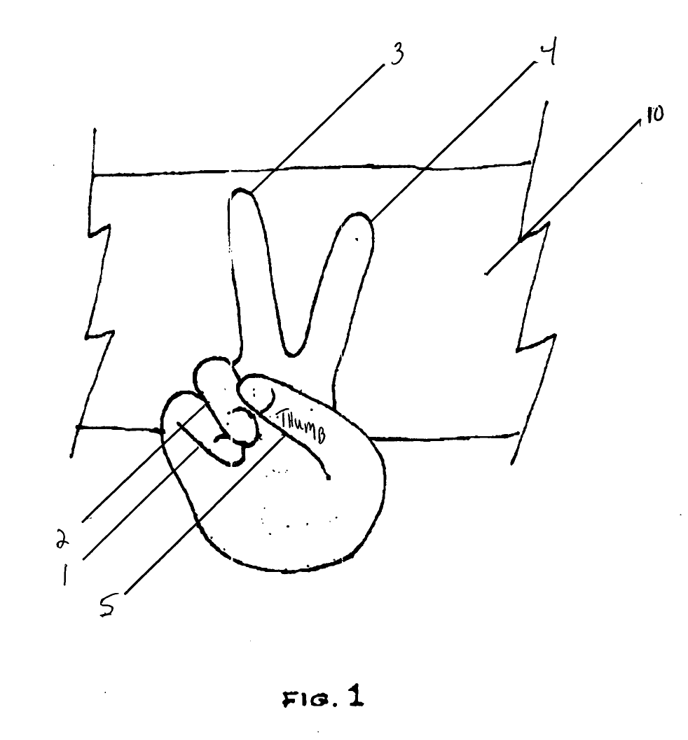

FIG. 1: This is a drawing of the present invention, which shows all the digits (#1,2,3,4,5) of the hand. This particular drawing shows the hand gesture “peace” with two digits (#3,4) erect and the remaining digits (#1,2,5) retracted. The male hitch (not visible, attached to the hand gesture) attaches to the receiving hitch (not visible) and is visible to any driver who is in the vicinity of the rear of the vehicle. The hitch is located just underneath the bumper (#10).

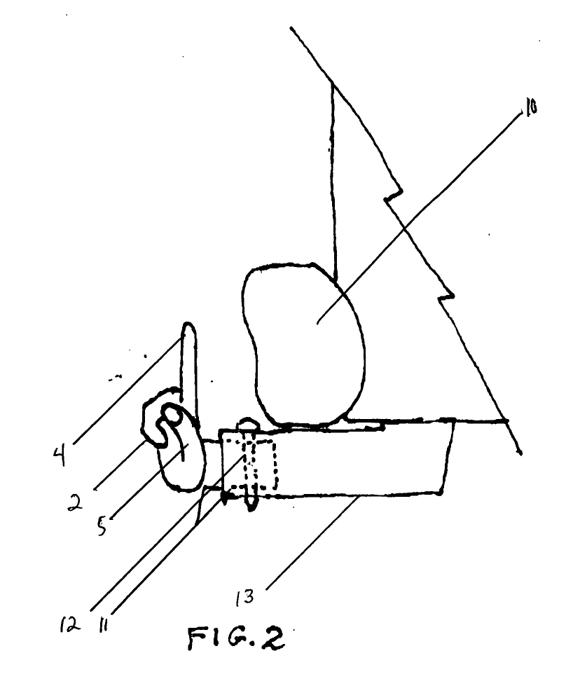

FIG. 2: The side view of the present invention shows how it is mounted to the receiving hitch (#13) of the automobile just beneath the bumper (#10). The present invention is displaying a “peace” sign with 2 digits (#3,4) erect and 3 digits (#1,2,5) retracted. The male hitch (#11), which is attached to the hand gestures, is inserted into the receiving hitch (#13) and then secured with a pin (#12) to ensure security. The drawing shows the male hitch insertion to be about 2″ inside the receiving hitch.

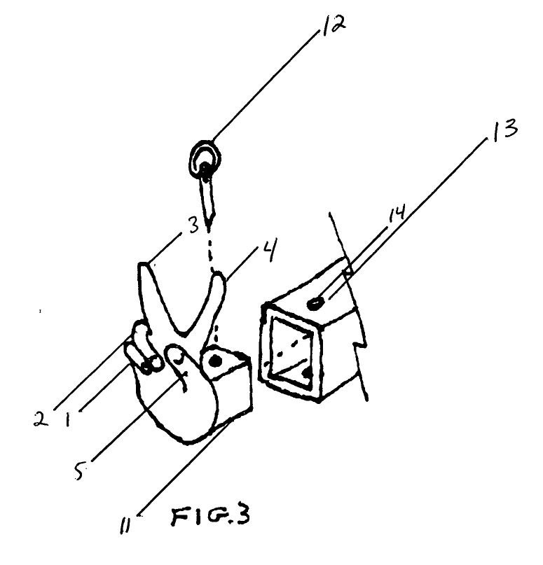

FIG. 3: This drawing is an exploded view of the present invention and how it is to be mounted to a trailer hitch receiver (#13). The present invention is, once again, displaying the “peace” sign with 2 digits (#3,4) erect and 3 digits (#1,2,5) retracted. The male hitch (#11), which is attached to the hand gestures, is inserted into the receiving hitch (#13) and then secured with a pin (#12). This pin (#12) is to be inserted through a hole (#14), which is located at the top of the receiving hitch (#13) to ensure security.

FIG. 4: This drawing shows the present invention in a skeleton view to show how the product can move to any position necessary to express yourself. The present invention is created by cast-molding a silicone rubber-based compound (V 1065) (#20) over one quarter inch aluminum armature wire (#19) strong and stiff enough to retain its position in adverse conditions such as winds or rain, yet flexible and pliable enough to attain any position necessary. The fingers and thumb can be positioned to mimic most hand gestures and hold their position once moved, unlike mannequin devices. The combination of these materials provide stable, yet flexible digits which feature position memory characteristics which are unique to any existing novelty receiver on the market today.

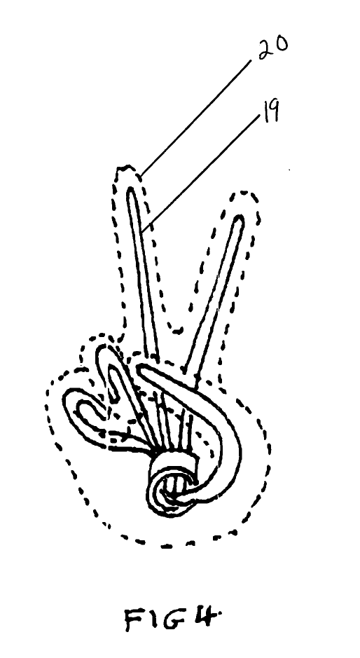

FIG. 5: This drawing shows a rear view of the present invention waving “hello”. This hand gesture requires the use of all the digits (#1-5) in an erect position, which is visible to motorists in the rear vicinity of the vehicle. The backdrop in which the present invention is visible against is the bumper (#10) located just above the trailer hitch.

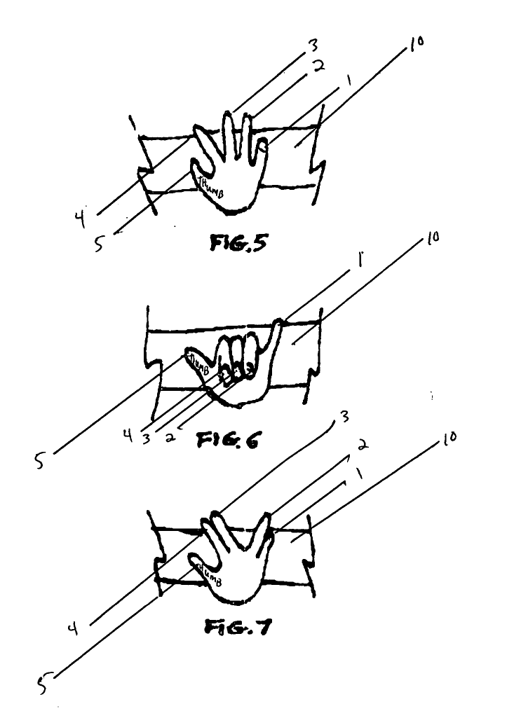

FIG. 6: This drawing shows a rear view of the present invention displaying a “hang loose” hand gesture. This hand gesture also requires the use of all the digits with the thumb (#5) and pinky (#1) erect and the remaining digits (#2,3,4) retracted visible to motorists in the rear vicinity of the vehicle. The backdrop in which the present invention is visible against is the bumper (#10) located just above the trailer hitch.

FIG. 7: This drawing shows a rear view of the present invention displaying an “alien handshake” hand gesture. This hand gesture requires the use of all the digits (#1-5) in an erect position with a space between digits 2 and 3, which is visible to motorists in the rear vicinity of the vehicle. The backdrop in which the present invention is visible against is the bumper (#10) located just above the trailer hitch.

1. A hand gesture device, comprising a pliable artificial hand with an attachment apparatus at the end of the wrist opposite the fingers, said attachment apparatus being suitable for connection to a trailer hitch on a motor vehicle; wherein said device is capable of being set in position and holding said position indefinitely while remaining attached to said trailer hitch, even during operation of said motor vehicle.

2. The hand gesture device of claim 1, further comprising a skeleton of stiff; yet bendable material.

3. The hand gesture device of claim 2, wherein said bendable material comprises metal wire.

4. The hand gesture device of claim 2, wherein said bendable material comprises one-quarter inch aluminum armature wire.

5. The hand gesture device of claim 1, wherein said device is composed substantially of polymeric plastic material covering a skeleton of metal wire.

6. The hand gesture device of claim 5, wherein said plastic material comprises a silicone rubber-based compound.
